(19) United States
(12) Patent Application Publication
(10) Pub. No.: US 2010/0079802 A1
(43) Pub. Date: Apr. 1, 2010

(54) IMAGE PROCESSING APPARATUS

(75) Inventor: Naoki KANAI, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Minato-ku, Tokyo (JP)

(21) Appl. No.: 12/566,720

(22) Filed: Sep. 25, 2009

(30) Foreign Application Priority Data
Sep. 26, 2008 (JP) 2008-247111

(51) Int. Cl. G06F 15/00

(52) U.S. Cl. 358/1.15

(57) ABSTRACT

An image processing apparatus capable of processing image data having plural pages includes a page designation unit, a page extraction unit, and an output unit. The page designation unit receives designation of a page to be printed. The page extraction unit extracts page data in a unit of pages from the image data based on the page designated through the page designation unit and page information included in the image data. The output unit outputs the page data extracted by the page extraction unit.

### BACKGROUND OF THE INVENTION

1. Field of the Invention

The present invention relates to an image processing apparatus processing image data having a plurality of pages.

2. Description of Related Art

Conventionally, in a case where file data having plural pages are prepared by an image processing apparatus based on various formats such as a portable document format (PDF), an XML paper specification (XPS), PostScript (trademark), a printer control language (PCL) (trademark), and a hyper text markup language (HTML), and are directly printed, the image processing apparatus transmits the file data with respect to an image forming apparatus capable of directly interpreting each of the formats, thereby executing the direct printing (e.g., Patent Document 1).

Patent Document 1: Japanese Un-examined Patent Application Publication No. 2002-358183

In a case where a specific page or pages need to be printed, however, such a prior art image processing apparatus transmits the file data as a whole prepared based on the above described formats to the image forming apparatus to print all of the pages, and then the user has to select the specific page or pages, so that extra labor is required. Moreover, the file data relating to non-specific pages are also transmitted to the image forming apparatus, causing a load on a network, for example, a local area network (LAN).

The present invention is proposed in consideration of the aforementioned conventional situations, and provides an image processing apparatus capable of directly printing a specific page or pages by designation of a page range and reducing a load of a network by not transmitting excess file data with respect to the network.

### BRIEF SUMMARY OF THE INVENTION

According to one aspect of the invention, an image processing apparatus is capable of processing image data having plural pages and includes: a page designation unit receiving designation of a page to be printed; a page extraction unit extracting page data in a unit of pages from the image data based on the page designated through the page designation unit and page information included in the image data; and an output unit outputting the page data extracted by the page extraction unit.

According to another aspect of the present invention, an image processing apparatus is capable of processing plural sets of image data, each of the sets having plural pages, and the image processing apparatus includes: a page designation unit receiving designation of a page to be printed; a page extraction unit extracting page data in a unit of pages from the image data based on the page designated through the page designation unit and page information included in the image data; and an output unit outputting the page data extracted by the page extraction unit.

Additional features and advantages of the present invention will be more fully apparent from the following detailed description of embodiments, the accompanying drawings and the associated claims.

### BRIEF DESCRIPTION OF THE DRAWINGS

A more complete appreciation of the aspects of the invention and many of the attendant advantage thereof will be readily obtained as the same becomes better understood by reference to the following detailed description when considered in connection with the accompanying drawings, wherein:

FIG. 1 is a block diagram illustrating a host computer serving as an image processing apparatus according to a first embodiment of the present invention;

FIG. 2 is a flowchart illustrating an example procedure for operating the host computer;

FIG. 3 is a schematic diagram illustrating image data having plural pages;

FIG. 4A is a schematic diagram illustrating an example of a selection display screen allowing a user to select execution of direct printing;

FIG. 4B is a schematic diagram illustrating another example of the selection display screen allowing the user to select the execution of direct printing;

FIG. 5 is a schematic diagram illustrating an example of a dialog screen used to facilitate the user to input a page range;

FIG. 6A is a schematic diagram illustrating an example of the image data;

FIG. 6B is a schematic diagram illustrating an example of extraction data;

FIG. 7 is a block diagram illustrating a host computer serving as an image processing apparatus according to a second embodiment of the present invention;

FIG. 8 is a flowchart illustrating an example procedure for operating the host computer;

FIG. 9 is a schematic diagram illustrating image data having plural pages;

FIG. 10A is a schematic diagram illustrating an example of a selection display screen allowing the user to select execution of direct printing;

FIG. 10B is a schematic diagram illustrating another example of the selection display screen allowing the user to select the execution of direct printing;

FIG. 11 is a schematic diagram illustrating an example of a dialog screen used to facilitate the user to input a page range;

FIG. 12 is a block diagram illustrating a host computer serving as an image processing apparatus according to a third embodiment of the present invention;

FIG. 13 is a block diagram illustrating a page extraction unit included in the host computer;

FIG. 14 is a schematic diagram illustrating an example of an ID table;

FIG. 15A is a schematic diagram illustrating an example of image data;

FIG. 15B is a schematic diagram illustrating an example of information stored in a page information storage portion;

FIG. 15C is a schematic diagram illustrating an example of file data;

FIG. 16 is a flowchart illustrating an example procedure for operating the host computer; and

FIG. 17 is a schematic diagram illustrating an example of a print range box displayed.

### DETAILED DESCRIPTION OF PREFERRED EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, like reference numerals designate identical or corresponding parts throughout the several views.

### First Embodiment

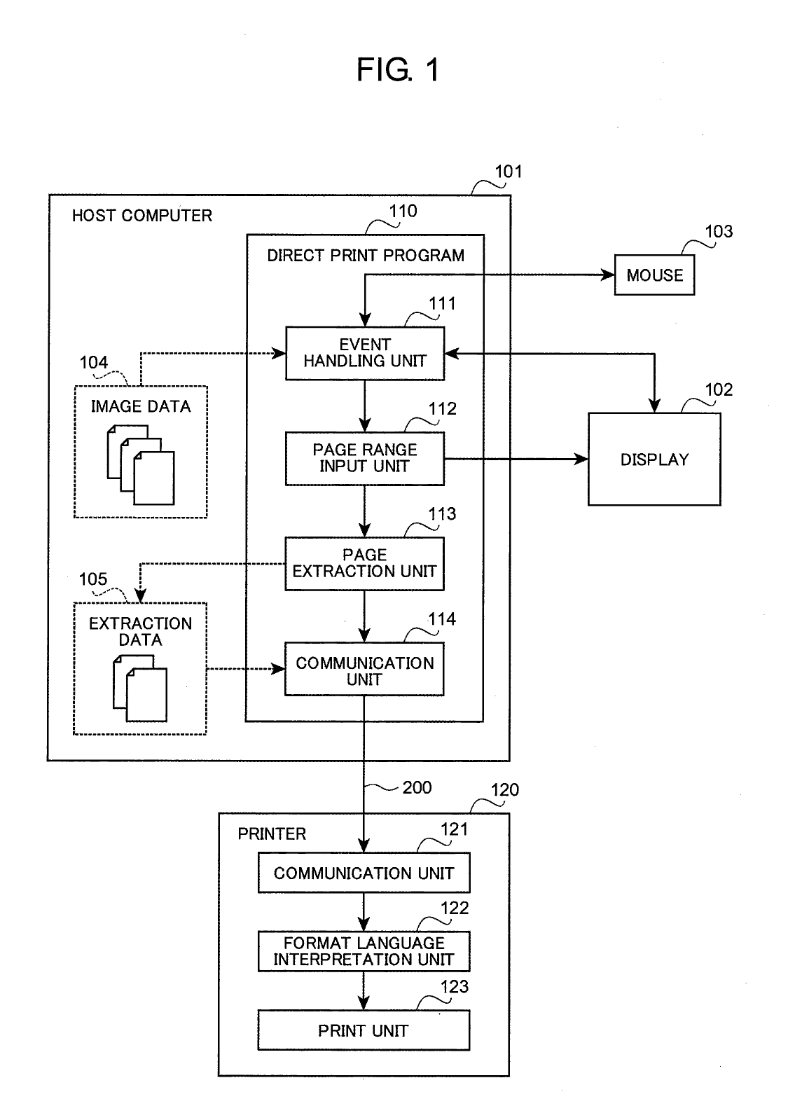

Referring to FIG. 1, a host computer 101 serving as an image processing apparatus according to a first embodiment is illustrated in a block diagram. The host computer 101 is configured as a general personal computer and includes: a display 102, serving as a display mechanism, for example, a cathode ray tube (CRT) display or liquid crystal display (LCD), displaying an apparatus state or various setting input screens and the like; and a mouse 103, serving as an input mechanism, receiving an input from a user through the various setting input screens displayed on the display 102. The host computer 101 is connected with a printer 120 serving as an image forming apparatus through a network 200.

A description is now given of the host computer 101. The host computer 101 includes: a central processing unit (CPU) (not shown) controlling the apparatus as a whole; a volatile storage device (not shown), for example, a random access memory (RAM), functioning as a working area of the CPU; a non-volatile storage device (not shown), for example, a read only memory (ROM) or a hard disk drive (HDD), storing an apparatus control program or a direct print program 110 (described later); and a communication control device (not shown), for example, a network card, controlling communications between the host computer 101 and the printer 120 by being connected to the network 200. The CPU controls each of such components through a system bus, so that the host computer 101 functions.

A description is now given of the direct print program 110. The direct print program 110 is installed in the host computer 101. The direct print program 110, serving as a program, performs a prescribed process with respect to data such as image data 104 on the host computer 101 and outputs the data with respect to the printer 120. The image data 104 not only serve as file data having plural pages prepared based on formats such as PDF, XPS, PostScript, PCL, and HTML, but also serve as image data printable by the printer 120 capable of directly receiving the file data of such formats.

The direct print program 110 includes: an event handling unit 111 detecting an event input through the input mechanism such as the mouse 103; a page range input unit 112 receiving an input of page range designated by the user; a page extraction unit 113 extracting the page range received through the page range input unit 112; and a communication unit 114 transmitting the data, for example, extraction data 105 extracted by the page extraction unit 113, to the printer 120.

Now, the printer 120 is described. The printer 120 includes: a communication unit 121 receiving the image data 104 and the extraction data 105 transmitted from the communication unit 114 of the direct print program 110; a format language interpretation unit 122 interpreting the format languages such as PDF, XPS, PostScript, PCL, and HTML described above, and rasterizing and converting into binary data printable by a print unit 123; and the print unit 123, for example, including a print engine employing an electrophotographic method, printing the binary data converted by the format language interpretation unit 122 on a recording medium such as a recording sheet.

The host computer 101 allows the page range to be designated, so that a specific page or pages can be printed by direct printing. The host computer 101 does not allow excess file data to be transmitted with respect to a network, thereby reducing a load of the network.

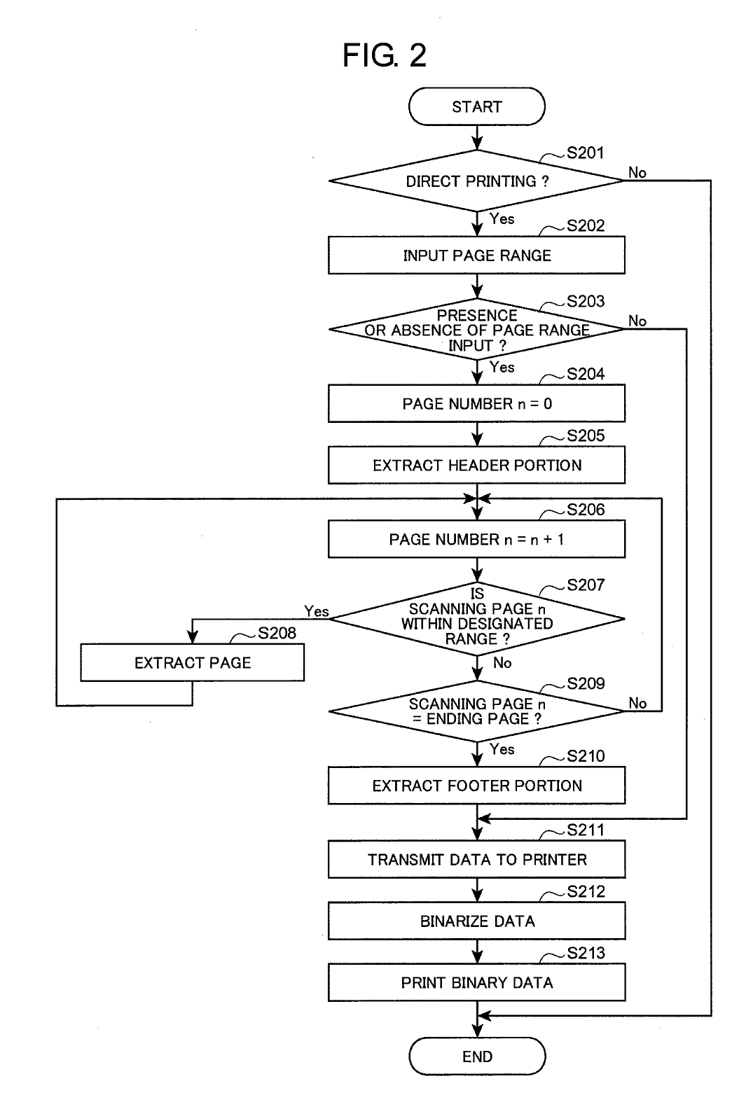

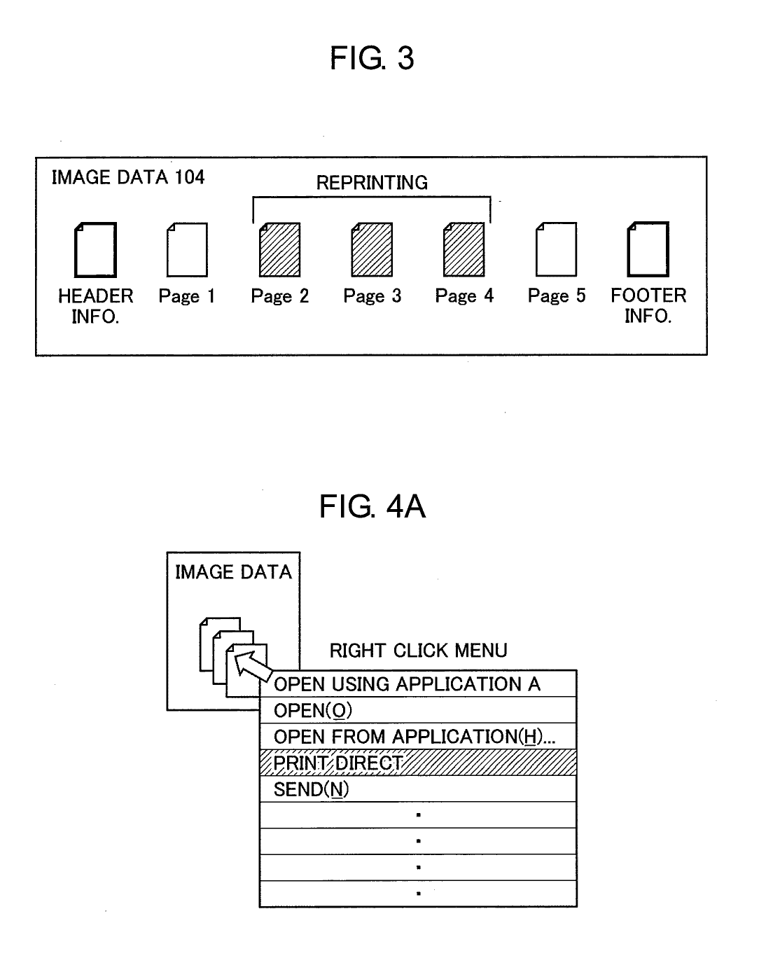

The operation of the host computer 101 according to the first embodiment is described with reference to a flowchart of FIG. 2 illustrating the operation thereof and a schematic diagram of FIG. 3 illustrating the image data 104 having plural pages. According to the first embodiment, the user designates an output page range with respect to the image data 104 as illustrated in FIG. 3, and the direct printing is executed to reprint the specific pages. For example, the image data 104 include header information and footer information of the document in addition to information of each page (e.g., pages 1 through 5) as illustrated in FIG. 3, and the information to be included depends on the format of the image data 104. Accordingly, for example, the image data 104 may include one of the header information and the footer information, or may lack for both of the header and footer information. In a following description, the pages 2 through 4 of the image data 104 in FIG. 3 are reprinted as an example situation.

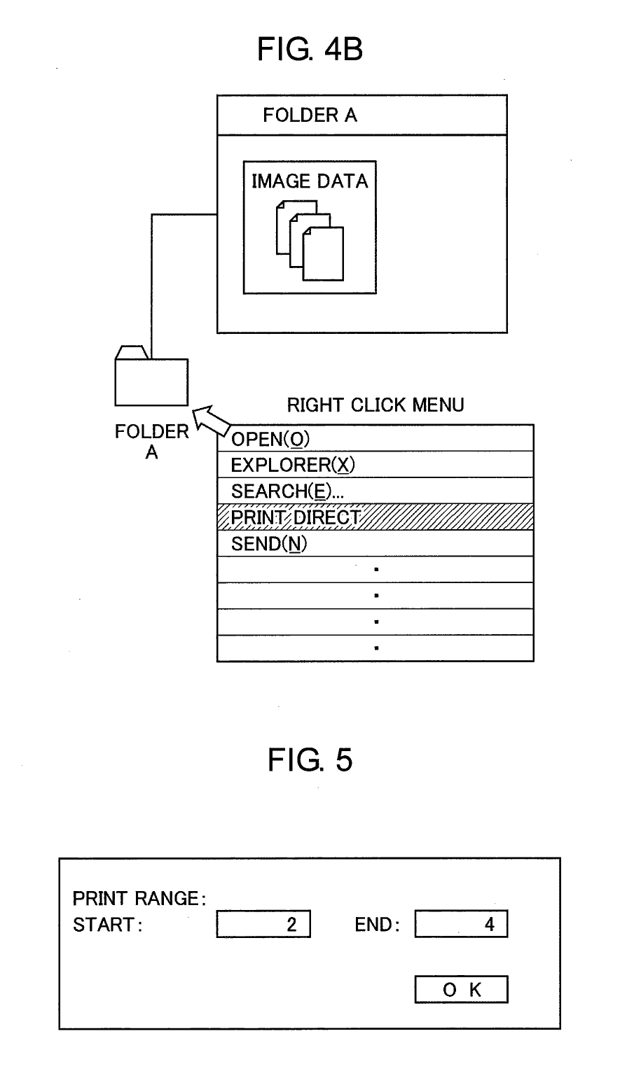

In a case where the user clicks an icon indicating the image data 104 displayed on the display 102 with the mouse 103, the event handling unit 111 of the direct print program 110 detects an event of a right-click and allows the display 102 to display a selection display screen as illustrated in FIG. 4A or FIG. 4B, so that the user can select execution of the direct printing (step S201). Where the user selects the direct printing (Yes in step S201), the event handling unit 111 notifies of selection of the direct printing to the page range input unit 112. Where the user does not select the direct printing (No in step S201), on the other hand, a flow ends.

Upon receiving the notification of the direct printing selection from the event handling unit 111, the page range input unit 112 allows the display 102 to display a dialog screen as illustrated in FIG. 5 to facilitate the user to input the page range.

Herein, in a case where the user inputs, for example, a numeral “2” as a start page and a numeral “4” as an end page in the dialog screen facilitating the input of the page range as illustrated in FIG. 5 (step S202), the page extraction unit 113 determines the presence or absence of the page range input (step S203). The page extraction unit 113 may determine the presence or absence of the page range input based on the presence or absence of the input of the start page and the end page. The page extraction unit 113 may determine the presence or absence of the page range input based on a situation where the start page is a natural number other than 1 and where the end page is equal to or not equal to a number of pages of the image data 104.

Where the page extraction unit 113 determines the absence of the page range input (No in step S203), the communication unit 114 directly transmits all of the image data 104 to the printer 120 (step 211).

Upon receiving the image data 104 through the communication unit 121, the printer 120 instructs the format language interpretation unit 122 to interpret the format language of the image data 104 received and to rasterize and convert into the binary data printable by the print unit 123.

Upon receiving the instruction, the format language interpretation unit 122 converts the image data 104 into the binary data (step S212) and outputs the binary data converted to the print unit 123. Upon being input with the binary data from the format language interpretation unit 122, the print unit 123 prints the image on the recording medium based on the binary data (step S213).

Where the page extraction unit 113 determines the presence of the page range input (Yes in step S203), the page extraction unit 113 sets zero (0) for a page number “n” (step S204) and scans the image data 104 from the top. In a case where a header portion exists, the page extraction unit 113 extracts the header portion (step S205). Herein, the header portion represents a portion as far as a data start portion on a first page of the image data 104. Since the header portion is dependent on the format of the image data 104 as described above, the header portion may not necessarily exist.

Subsequently, the page extraction unit 113 counts up the page number “n” as “n=n+1” (step S206), and compares the page “n” in the process of scanning and the page range input by the user through the page range input unit 112 to determine whether or not the page “n” in the process of scanning is within the page range input by the user (step S207).

Where the page “n” in the process of scanning is within the page range input by the user through the page range input unit 112 (Yes in step S207), the page extraction unit 113 extracts the scanning page “n” (step S208). Herein, the “extraction” represents a situation in which the scanning page “n” is temporarily copied, for example, in a storage unit (not shown). Where the page “n” in the process of scanning is not within the page range input by the user through the page range input unit 112 (No in step S207), the page extraction unit 113 determines whether or not the page number “n” in the process of scanning is the end page (step S209).

Where the page number “n” in the process of scanning is not the end page (No in step S209), a flow returns to and repeats step S206 by the page extraction unit 113. Where the page number “n” in the process of scanning is the end page (Yes in step S209), the page extraction unit 113 scans as far as the last page of the image data 104 and extracts a footer portion (step S210). Herein, the footer portion represents a portion from an end of data on the last page of the image data 104 to an end of the image data 104.

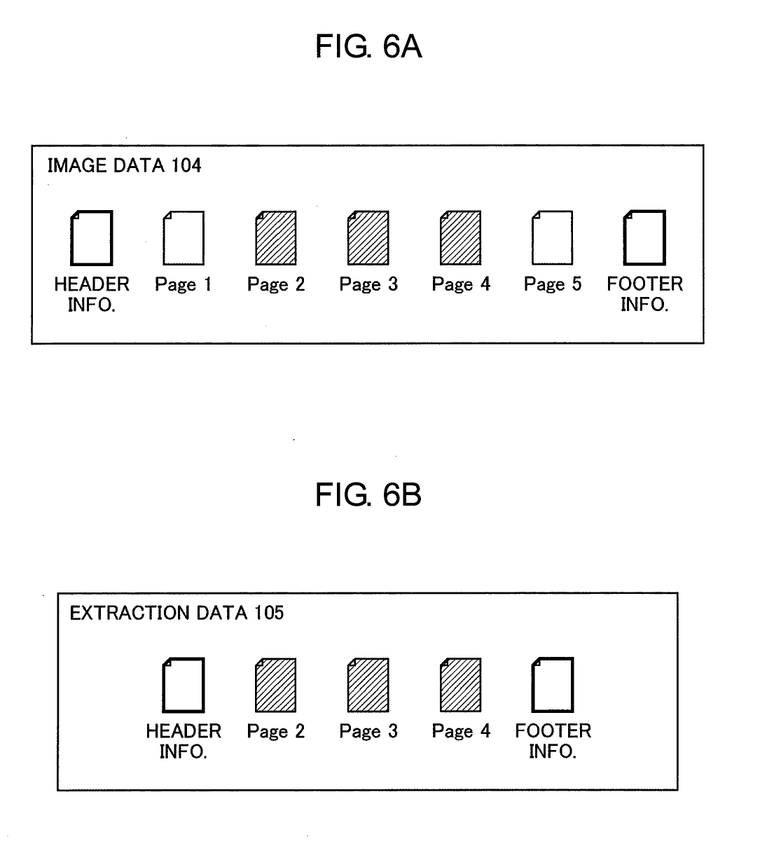

Therefore, the extraction data 105 are extracted as illustrated in FIG. 6B by the page extraction unit 113 from the image data 104 as illustrated in FIG. 6A.

The communication unit 114 transmits the extraction data 105 extracted by the page extraction unit 113 to the printer 120 (step S211).

The printer 120 receives the extraction data 105 through the communication unit 121 and instructs the format language interpretation unit 122 to interpret the format language of the extraction data 105 extracted and to rasterize the data as well as convert into the binary data printable by the print unit 123.

Upon receiving the instruction, the format language interpretation unit 122 converts the extraction data 105 into the binary data (step S212) and outputs the binary data converted to the print unit 123. Upon being input with the binary data from the format language interpretation unit 122, the print unit 123 prints the image on the recording medium based on the binary data (step S213).

According to the above first embodiment, the page range is designated to print the specific page or pages by the direct printing, and the specific pages are extracted in the host computer 101 instead of the printer 120, so that file data of a portion not necessarily to be printed are not transmitted to the printer 120, thereby reducing a load of the network.

### Second Embodiment

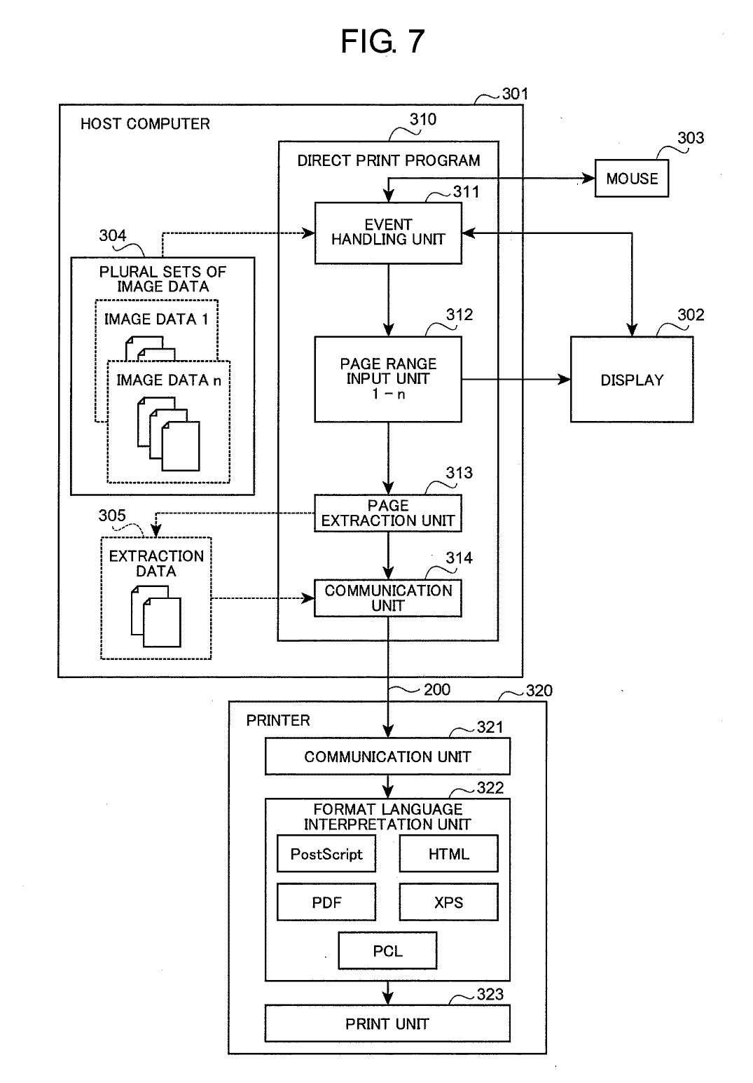

Referring to FIG. 7, a host computer 301 serving as an image processing apparatus according to a second embodiment is illustrated in a block diagram. The host computer 301 is configured as a general personal computer and includes: a display 302, serving as a display mechanism, for example, a cathode ray tube (CRT) display or LCD, displaying an apparatus state or various setting input screens and the like; and a mouse 303, serving as an input mechanism, receiving an input from a user through the various setting input screens displayed on the display 302. The host computer 301 is connected with a printer 320 serving as an image forming apparatus through a network 200.

The host computer 301 is now described. The host computer 301 includes: a central processing unit (CPU) (not shown) controlling the apparatus as a whole; a volatile storage device (not shown), for example, a random access memory (RAM), functioning as a working area of the CPU; a non-volatile storage device (not shown), for example, a read only memory (ROM) or a hard disk drive (HDD), storing an apparatus control program or a direct print program 310 (described later); and a communication control device (not shown), for example, a network card, controlling communications between the host computer 301 and the printer 320 by being connected to the network 200. The CPU controls each of such components through a system bus, so that the host computer 301 functions.

A description is now given of the direct print program 310. The direct print program 310 is installed in the host computer 301. The direct print program 310, serving as a program, performs a prescribed process with respect to data such as image data (1-n) of plural sets of image data 304 on the host computer 301 and sequentially outputs the data with respect to the printer 320. The image data (1-n) of the plural sets of image data 304 not only serve as file data having plural pages prepared based on formats such as PDF, XPS, PostScript, PCL, and HTML, but also serve as image data printable by the printer 320 capable of directly receiving the file data of such formats. The plural sets of image data 304 include a plurality of the image data, and each set of the image data may be formed in a different format. For example, image data 1 may be formed in the PDF format, and image data 2 may be formed in the XPS format.

The direct print program 310 includes: an event handling unit 311 detecting an event input through the input mechanism such as the mouse 303; a page range input unit 312 receiving an input of page range designated by the user; a page extraction unit 313 extracting the page range received through the page range input unit 312; and a communication unit 314 transmitting, for example, extraction data 305 extracted by the page extraction unit 313 to the printer 320. According to the second embodiment, the number of the page extraction unit 313 is one. However, a plurality of page extraction units 313 may be disposed with respect to each print job.

Now, the printer 320 is described. The printer 320 includes: a communication unit 321 receiving, for example, the extraction data 305 transmitted from the communication unit 314 of the direct print program 310; a format language interpretation unit 322 interpreting the format languages such as PDF, XPS, PostScript, PCL, and HTML described above, and rasterizing and converting into binary data printable by a print unit 323; and the print unit 323, for example, including a print engine employing an electrophotographic method, printing the binary data converted by the format language interpretation unit 322 on a recording medium such as a recording sheet.

The host computer 301 allows the page range to be designated, so that a specific page or pages can be printed by direct printing. The host computer 301 does not allow excess file data to be transmitted with respect to a network, thereby reducing a load of the network.

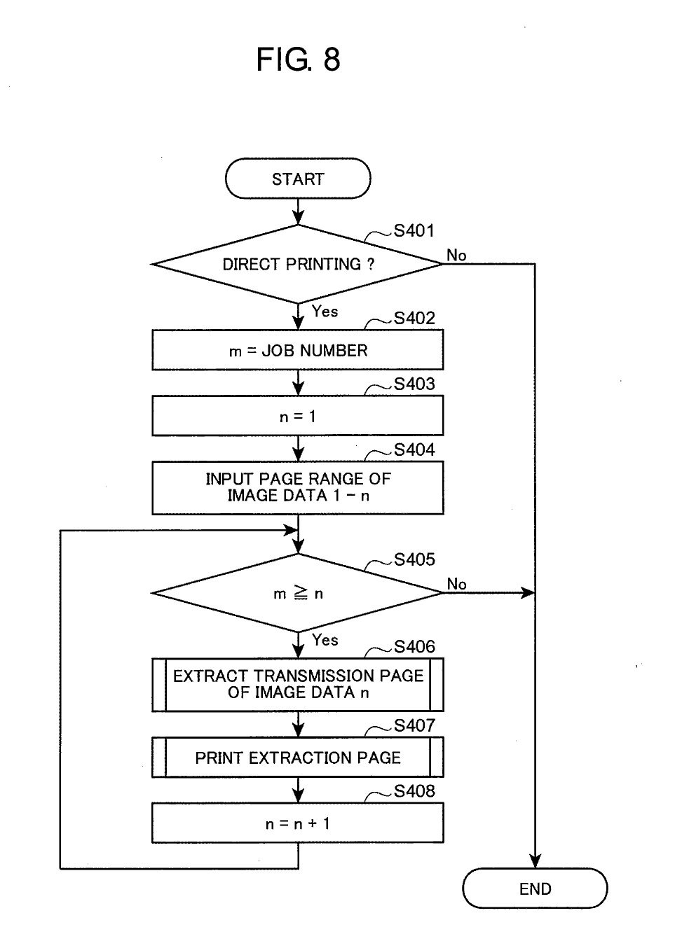

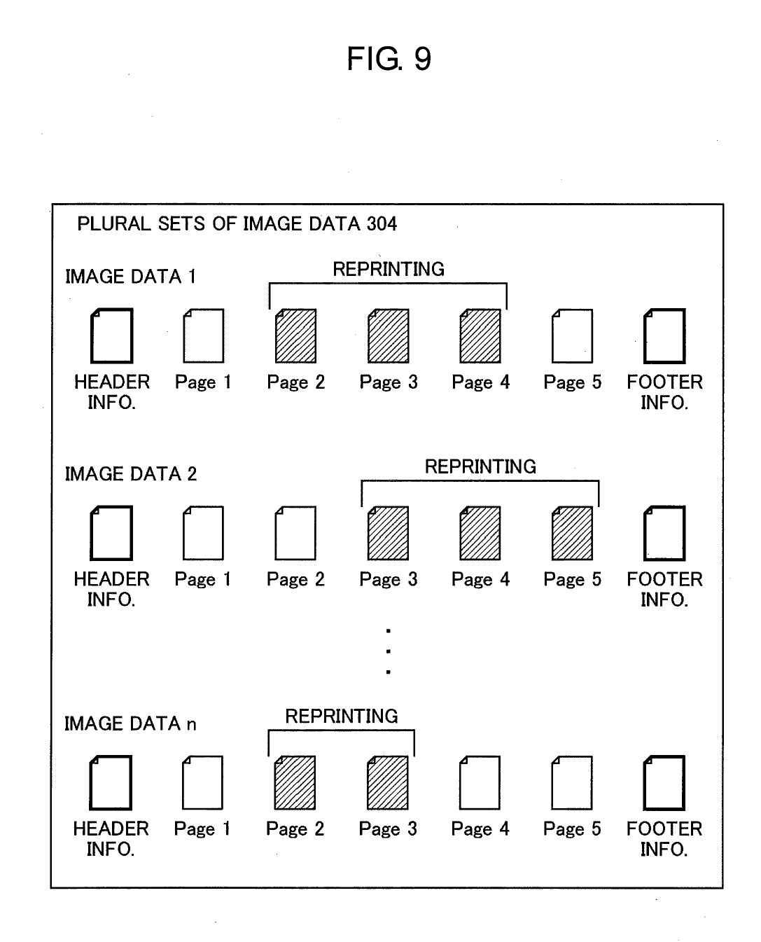

The operation of the host computer 301 according to the second embodiment is described with reference to a flowchart of FIG. 8. As for the plural sets of image data 304, each set of the image data has plural pages as illustrated in FIG. 9. According to the second embodiment, the user designates an output page range with respect to the image data (1-n) of respective plural sets of image data 304, and the direct printing is executed to reprint the specific pages. In the plural sets of image data 304 as illustrated in FIG. 9, for example, each set of the image data includes header information and footer information of the document in addition to page information (e.g., Image Data 1: pages 2 through 4, Image Data 2: pages 3 through 5, Image Data “n”: pages 2 and 3), and the information to be included depends on the format of the plural sets of image data 304. Accordingly, for example, one of the header information or the footer information may be included, or neither of the header nor footer information may be included.

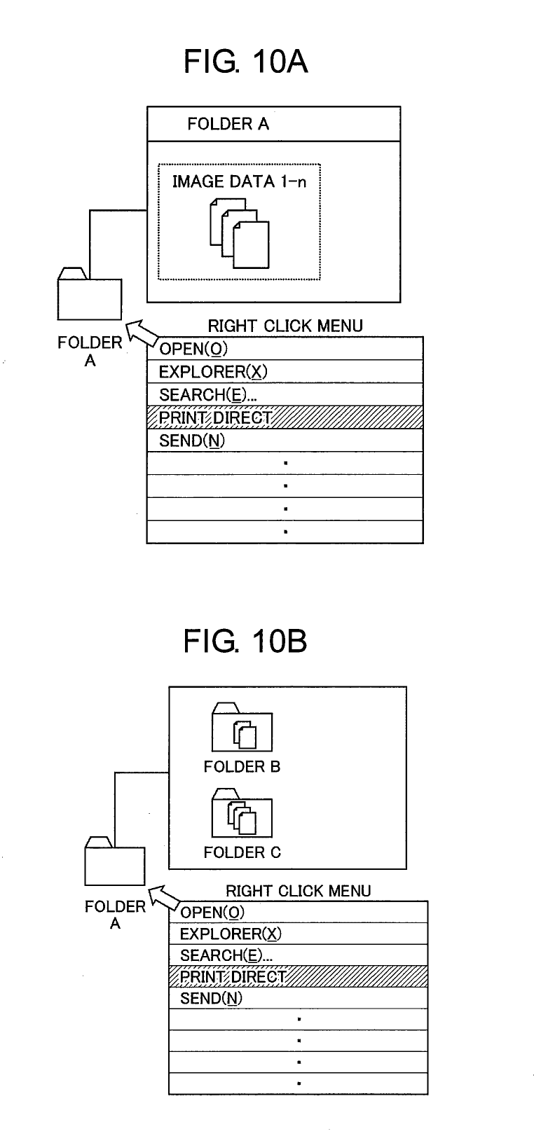

In a case where the user clicks an icon indicating the plural sets of image data 304 displayed on the display 302 with the mouse 303, the event handling unit 311 of the direct print program 310 detects an event of a right-click and allows the display 302 to display a selection display screen as illustrated in FIG. 10A or FIG. 10B, so that the user can select execution of the direct printing (step S401). Where the user does not select the direct printing (No in step S401), a flow ends. The plural sets of image data 304, for example, may be directly located under a folder “A” selected with the right-click by the user as illustrated in FIG. 10A, or may be located in sub-folders such as sub-folders “B” and “C” in the folder “A” selected with the right-click by the user as illustrated in FIG. 10B.

Where the user selects execution of the direct printing (Yes in Step S401), the event handling unit 311 extracts the image data capable of being received directly and printed by the printer 320 from the plural sets of image data 304 located in the folder selected with the right-click by the user, so that a job number “m” serving as an image data number is determined (step S402). Herein, the event handling unit 311 only extracts the image data of which the file data of the format can be received directly and printed by the printer 320. The event handling unit 311 sets “1” for an initial value of an index value “n” of the image data being in the process (step S403), and notifies of selection of the direct printing to the page range input unit 312.

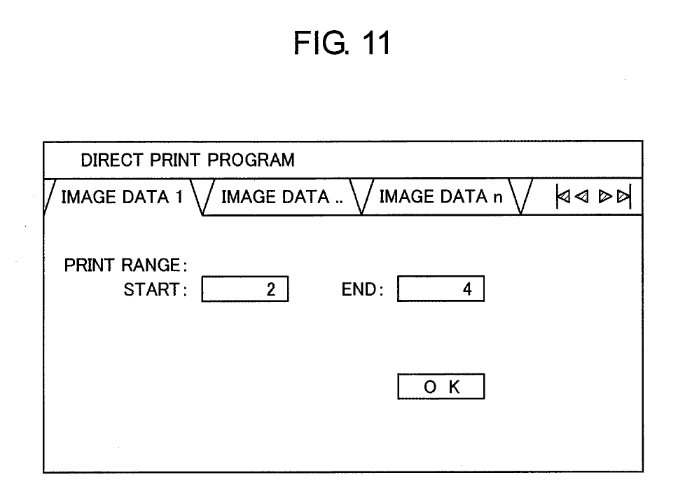

Upon receiving the notification of the direct printing selection from the event handling unit 311, the page range input unit 312 allows the display 302 to display a dialog screen as illustrated in FIG. 11 to facilitate the user to input the page range with respect to each set of image data (1-n). As illustrated in FIG. 11, dialog sheets are allocated to the respective image data, for example, one dialog sheet is allocated to one section of the image data, so that the page ranges for the image data are designated using respective sheets. However, for example, the image data may be displayed in a TreeView format to facilitate the user to select the image data, and the page range input may be allocated with respect to the image data selected.

For example, in a case where the user inputs the page range through the dialog screen facilitating the input of the page range with respect to each of the image data (1-n) as illustrated in FIG. 11 (step S404), the page extraction unit 313 compares the index value “n” of the image data and the job number “m” and determines whether or not printing operation for the image data is completed (step S405).

Where the job number “m” is below the index number “n” (No in step S405), the printing operation for all of the image data is completed, and a flow ends. Where the job number “m” is greater than or equal to the index number “n” of the image data (Yes in step S405), on the other hand, the page extraction unit 313 generates the extraction data 305 of the image data “n” by the processes similar to step S202 through S210 described above with reference to the flowchart of FIG. 2 of the first embodiment of the present invention (step S406).

The communication unit 314 transmits the extraction data 305 extracted by the page extraction unit 313 to the printer 320. Upon receiving the extraction data 305 through the communication unit 321, the printer 320 prints an image on the recording medium based on binary data by performing the processes similar to step S211 through S213 described above with reference to the flowchart of FIG. 2 of the first embodiment (step S407).

Subsequently, the page extraction unit 313 counts up the index number “n” of the image data being in the process as “n=n+1” (step S408). The page extraction unit 313 repeats the extraction and printing of the pages until the job number “m” is exceeded in step S405, thereby executing the print operation for all of the image data.

According to the second embodiment, therefore, the page range is designated to print the specific page or pages by the direct printing, and the extra labor caused by the reprint designation with respect to each of the plural sets of image data stored in the selected folder can be reduced.

### Third Embodiment

According to a third embodiment of the present invention, a host computer 501 serving as an image processing apparatus and a printer 520 serving as an image forming apparatus are respectively similar to the host computer 101 and the printer 120 of the first embodiment of the present invention described above. Components that differ from those of the first embodiment will be described, and a description of like components will be omitted for the sake of simplicity.

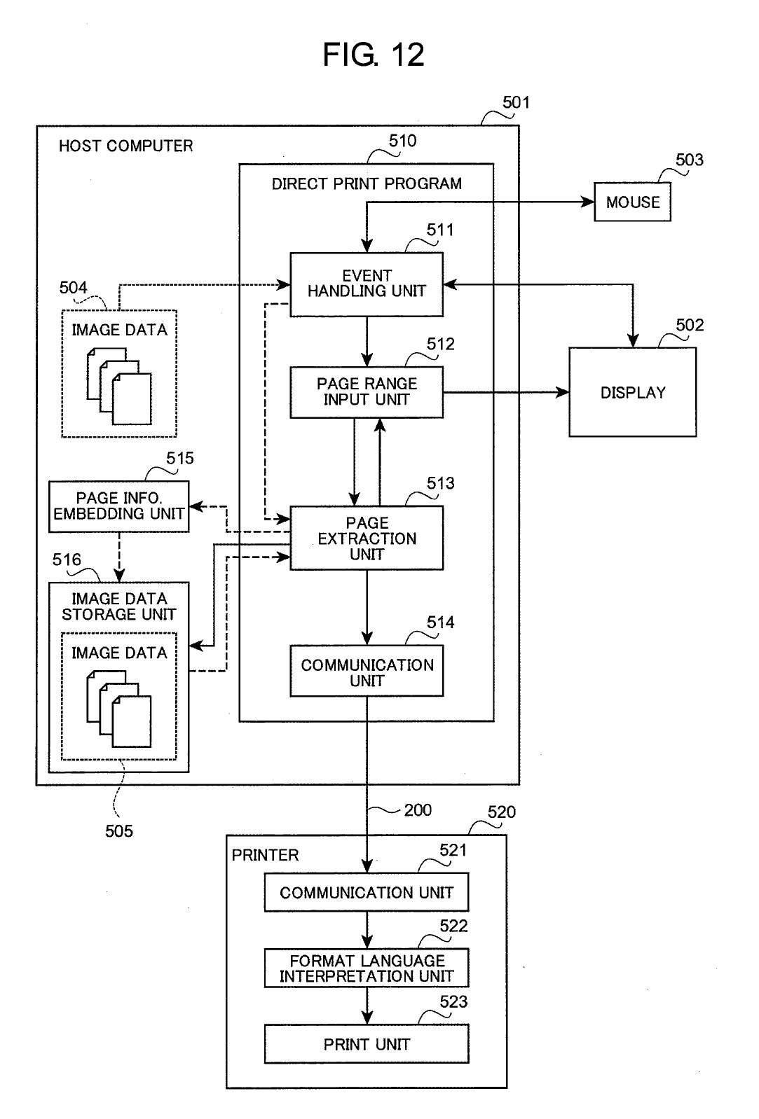

Referring to FIG. 12, the host computer 501 according to the third embodiment is illustrated in a block diagram. The host computer 501 includes: a page extraction unit 513 instead of the page extraction unit 113 of the host computer 101 according to the first embodiment; a page information embedding unit 515; and an image data storage unit 516.

The page extraction unit 513 determines whether or not image data input are already registered, and extracts page data in a unit of pages from the image data according to a page range input by a user through a page range input unit 512.

The page information embedding unit 515 newly generates page information image data 505 (also referred to as “image data with page information 505”) by embedding page information in the image data in a case where the image data are not registered.

The image data storage unit 516, for example, includes a non-volatile memory such as a HDD and a flash memory and stores the page information image data 505 generated in the page information embedding unit 515.

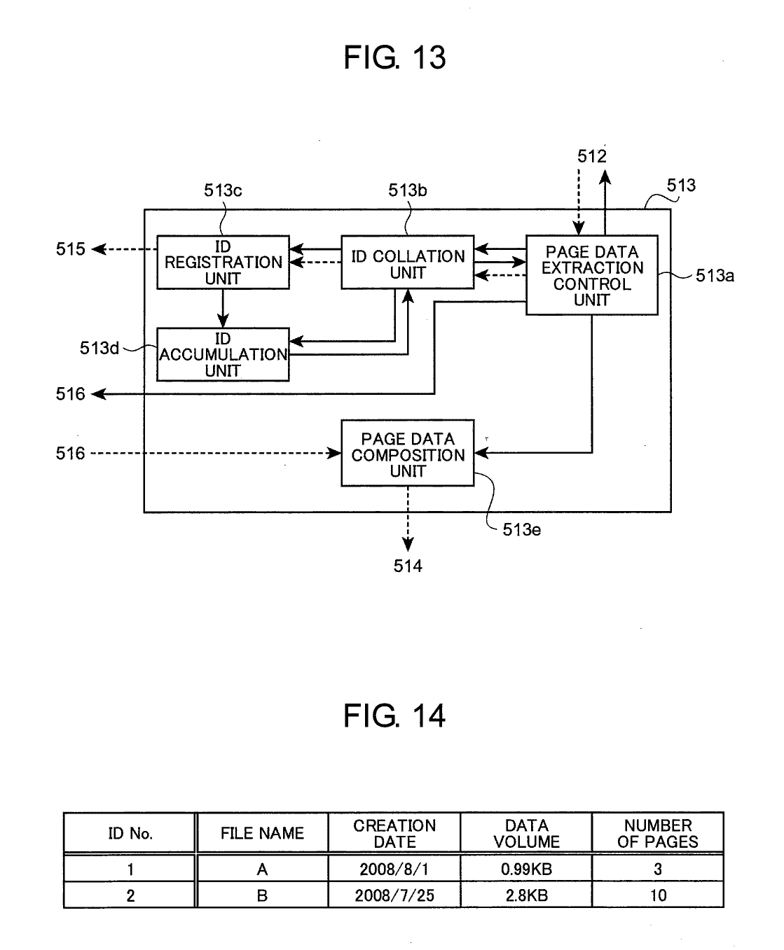

Referring to FIG. 13, the page extraction unit 513 is illustrated in a block diagram. The page extraction unit 513 includes a page data extraction control unit 513a not only controlling image data collation whether or not the image data are already registered but also controlling extraction operation of the page data. The page extraction unit 513 also includes: an ID collation unit 513b being connected to the page data extraction control unit 513a and collating ID of the image data; an ID registration unit 513c registering the ID in a case where the image data are not yet registered; an ID accumulation unit 513d including, for example, a non-volatile memory such as a HDD, and accumulating registration information of the image data; and a page data composition unit 513e extracting the corresponding page data from the image data storage unit 516 according to a command from the page data extraction control unit 513a and composing each set of the page data into one file data.

Herein, the registration information to be accumulated in the ID accumulation unit 513d includes: an ID number given to the image data in the course of registration; a file name; a date on which the image data are created; volume of the image data; and the number of pages of the image data as illustrated in FIG. 14.

A description is now given of the image data using image data 504 as an example. The image data 504 include: header having the “file name,” “file creation date,” and “data volume”; and the page data delimited with respect to each page. The “file name,” “file creation date,” and “data volume” are written in the header whenever the image data 504 are created or edited. The information to be written in the header may include additional information as needed. The page information image data 505 generated by the page information embedding unit 515 and stored in the image data storage unit 516, on the other hand, include a page information storage portion 505a in a top of the header in addition to the structure of the image data 504. That is, the image data 505 include the page information storage portion 505a, a header 505b, first page data 505c, second page data 505d, and third page data 505e as illustrated in 15A.

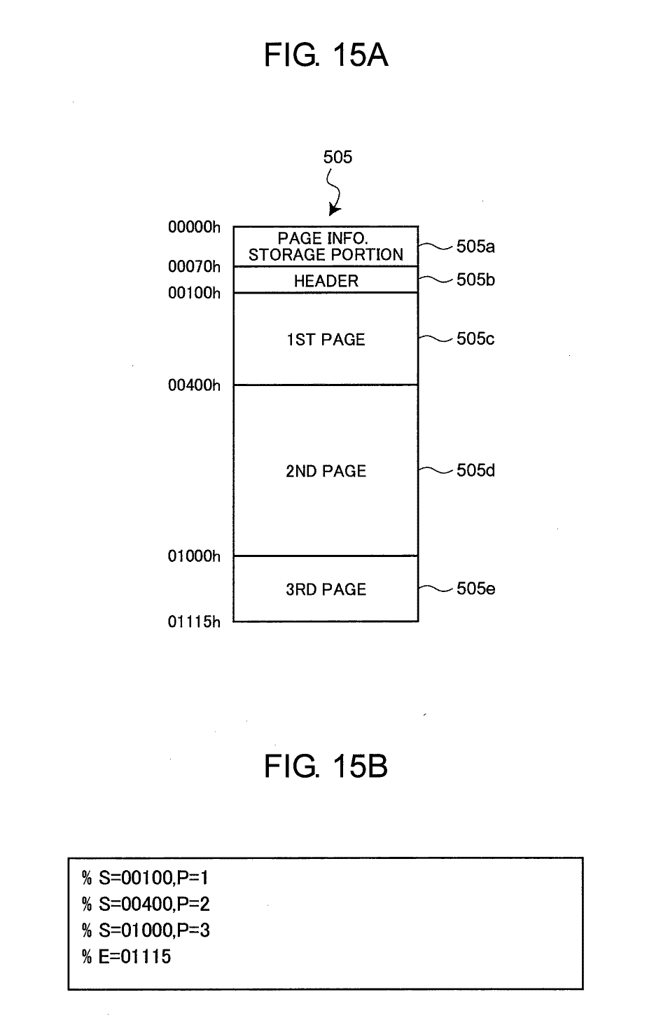

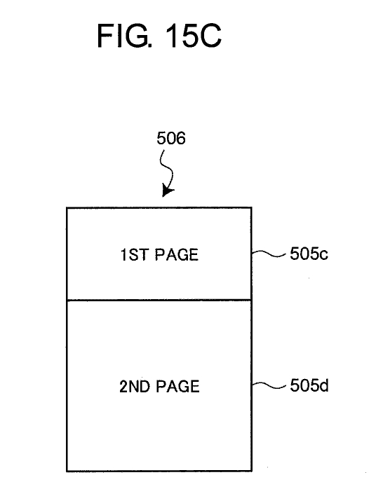

The page information storage portion 505a includes page information of a relative address in which each of the pages is stored on the file data as illustrated in FIG. 15B. Regarding a PostScript command, for example, a line with “%” is ignored as not a print command. The page information storage portion 505a includes a start address S and the page number P of each of the page data or an end address E of the image data 505. For example, a line “% S=00100, P=1” indicates that the start address S is 00100h and the page data are on the first page (P=1). Another line “% E=01115h” indicates that the end address E is 01115h.

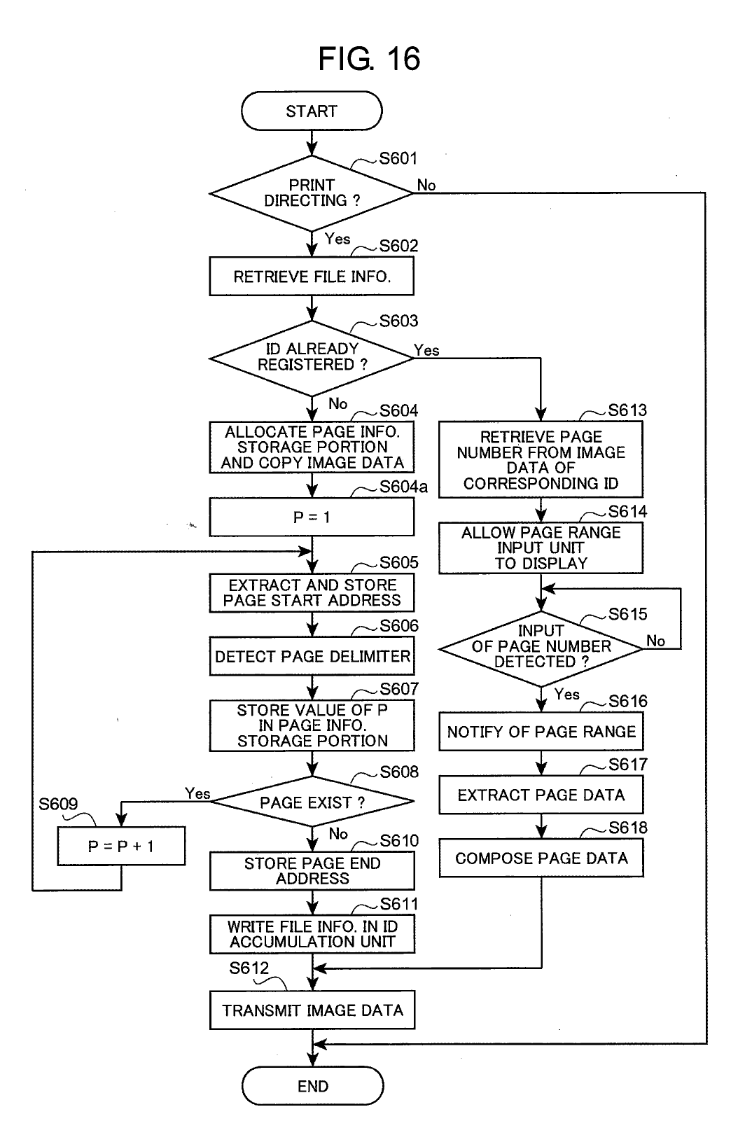

Referring to a flowchart of FIG. 16, an example procedure of the host computer 501 according to the third embodiment is described.

In a case where the user clicks an icon indicating the image data 504 displayed on the display 502 with a mouse 503, an event handling unit 511 of a direct print program 510 detects an event of a right-click and allows the display 502 to display a selection display screen as similar to FIG. 4A or FIG. 4B, so that the user can select execution of the direct printing (step S601). Where the user selects the direct printing (Yes in step S601), the event handling unit 511 outputs the image data 504 with respect to the page extraction unit 513. Where the user does not select the direct printing (No in step S601) on the other hand, a flow ends.

Upon being input with the image data 504, the page extraction unit 513 retrieves the file information (e.g., “file name,” “file creation date,” and “data volume”) from the header 505b of the image data 504 input through the event handling unit 511 (step S602).

Subsequently, the page data extraction unit 513a instructs the ID collation unit 513b to output and check the file information of the image data 504, so that the page data extraction unit 513a can determine whether or not the file information is already registered in the ID accumulation unit 513d. Upon receiving the instruction, the ID collation unit 513b searches the “file name,” “file creation date,” and “data volume” being congruent with the file information in the ID accumulation unit 513d, and examines whether or not the image data 504 are already registered (step S603).

Where the ID collation unit 513b does not find the ID information corresponding to the image data 504 and fails in the collation (No in step S603), the page data extraction control unit 513a determines that the image data 504 are not yet registered. The page data extraction control unit 513a allocates the page information storage portion 505a to the image data storage unit 516 through the page information embedding unit 515 and copies the image data 504 (step S604). Herein, the page data extraction control unit 513a sets a value of a page counter “P” to be “P=1” (step S604a).

Subsequently, the page data extraction control unit 513a retrieve the page data 505c copied in the image data storage unit 516. Herein, the page data extraction control unit 513a extracts the start address “00100h” and stores the page start address “S=00100” in the page information storage portion 505a (step S605). The page data extraction control unit 513a continues to retrieve the page data 505c and recognizes the page delimiter by detecting a “Showpage” command indicating the end of the page (step S606). Herein, since the value of the page counter “P” is 1, the page data extraction control unit 513a stores “P=1” after the page start address of the page information storage portion 505a (step S607).

The page data extraction control unit 513a examines whether or not the page data of the image data exist (step S608). Where the page data of the image data exist (Yes in step S608), the page data extraction control unit 513a increments the value of the page counter “P” by 1 (step S609), and a flow returns to step S605 to repeat step S605 through S607 by the page data extraction unit 513a until the last page. Where the page data of the image data do not exist (No in step S608), the page data extraction control unit 513a stores the end address of the page data “E=01115” in the page information storage portion 505a (step S610). FIG. 15B illustrates an example content of the page information storage portion 505a written as described above.

The page extraction control unit 513a retrieves the file information (e.g., “A” as the file name, “2008/8/1” as the creation date of the image data, and “0.99 KB” as the data volume of the image data) and the page counter “P” (P=3), and writes in an ID table of the ID accumulation unit 513d through the ID registration unit 513c.

Accordingly, the file information is written in a row of an ID number “1” in the ID table of the ID accumulation unit 513d as illustrated in FIG. 14. For example, the file name “A,” the creation date of “2008/8/1” on which the image data are created, the image data volume of “0.99 KB,” and the page number of “3” are written as illustrated in the ID table of FIG. 14. Herein, a row of the ID number “2” in the ID table of FIG. 14 represents the information written in a previous time.

Where the page data extraction control unit 513a determines that the image data 504 are already registered in the ID number “1” based on a collation result of the image data 504 with the ID table (Yes in step S603), the page data extraction control unit 513a retrieves the page number “3” for the ID number “1” from the image data storage unit 516 (step S613).

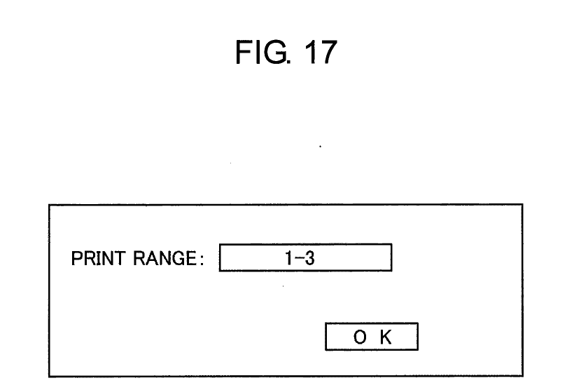

The page data extraction control unit 513a instructs the page range input unit 512 to enter and display “1-3” indicating a first page through a third page in a print range box on the display 502 as illustrated in FIG. 17. Upon receiving the instruction, the page range input unit 512 enters and displays “1-3” in the print range box on the display 502 (step S614). The print range is default information and may be changed by the user as needed.

Herein, in a case where the user inputs the page number in the print range box, the event handling unit 511 detects the input of the page number (step S615) and notifies the page data extraction control unit 513a of the page range to be printed (step S616). Where the event handling unit 511 detects the input of the page number (Yes in step S615), a flow proceeds to step S616. Where the event handling unit 511 does not detect the input of the page number (No in step S615), on the other hand, a flow stands by for an input of the page number. In a following description, numbers with hyphen, for example, “1-2” indicating the first page through second page, are entered in the print range box by the user. However, the numbers may be input using a comma, for example, “2, 3” (e.g, second page and third page) in the print range box in a case where optional numbers are designated from 1 through 3.

The page data extraction control unit 513a searches and extracts the page information image data 505 corresponding to the ID number “1” from the image data storage unit 516 (step S617). That is, the page data extraction control unit 513a retrieves the page information storage portion 505a of the image data 505, and recognizes the top address S “00100h” of the first page P=1. The page data extraction control unit 513a begins to retrieve the page data from the top address 00100h of the image data 505 and detects “Showpage,” thereby extracting the page data of the first page and outputting the page data to the page data composition unit 513e. Subsequently, the page data extraction control unit 513a recognizes the top address S “0400h” of the second page P=2 according to the page information storage portion 505a. The page data extraction unit 513a begins to retrieve from the address 00400h of the image data 505 and detects “Showpage,” thereby extracting the page data of the second page and outputting the page data to the page data composition unit 513e.

Subsequently, the page data composition unit 513e composes the page data 505c of the first page and the page data 505d of the second page, thereby forming one file data 506 as illustrated in FIG. 15C (step S618). The file data 506 do not include the header as illustrated in FIG. 15C. However, the file data 506 may include the file information (e.g., “file name,” “file creation date,” and “data volume”) as needed. The file data composed in the page data composition unit 513e are transmitted to the printer 520 (step S612).

Modification

According the third embodiment of the present invention described above, the image data 505 having the page information storage portion 505a are stored in the image data storage unit 516, and the ID accumulation unit 513d storing the file information of the image data 504 is disposed to collate the image data 504 and the image data 505 having the page information storage portion 505a, thereby determining whether or not the file is already registered. According to a modification of the third embodiment, the image data 505 having the page information storage portion 505a may be overwritten on the image data 504. Herein, the page information storage portion 505a is determined whether or not being retrieved, thereby determining whether or not the file data are already registered. That is, in a case where the page information storage portion 505a is not retrieved, the file data are determined as being not registered. In a case where the page information storage portion 505a is retrieved, on the other hand, the file data are determined as being already registered.

According to the above third embodiment, the page information storage portion 505a is positioned in the top of the image data 505. However, a position of the page information storage portion 505a is not limited thereto, and the page information storage portion 505a may be optionally positioned as long as information thereof can be retrievable.

According to the above third embodiment, the page information storage portion 505a includes the start address indicating the top position of the page and the page number. Alternatively, the page information storage portion 505a may be included in a top or an end of each of the pages with the page counter “P.” Accordingly, a specific page or pages can be extracted by sequentially searching the page information.

According to the first, second, and third embodiments of the present invention, the printer is described as the image forming apparatus. However, the embodiments of the present invention are not limited thereto. The present invention may be applied to, for example, a facsimile machine, a copier, and a multi-functional peripheral including an image reading apparatus such as a scanner in addition to the printer. According to the above embodiments, the print engine employing the electrophotographic method is described as an example of the print unit. However, a print engine employing any method, for example, an ink jet method and a thermal transfer method, may be used.

As can be appreciated by those skilled in the art, numerous additional modifications and variation of the present invention are possible in light of the above-described teachings. It is therefore to be understood that, within the scope of the appended claims, the disclosure of this patent specification may be practiced otherwise than as specifically described herein.

What is claimed is:

1. An image processing apparatus processing image data having plural pages, the image processing apparatus comprising:
a page designation unit receiving designation of a page to be printed;
a page extraction unit extracting page data in a unit of pages from the image data based on the page designated through the page designation unit and page information included in the image data; and
an output unit outputting the page data extracted by the page extraction unit.

2. An image processing apparatus processing plural sets of image data, each of the sets having plural pages, the image processing apparatus comprising:
a page designation unit receiving designation of a page to be printed;
a page extraction unit extracting page data in a unit of pages from the image data based on the page designated through the page designation unit and page information included in the image data; and
an output unit outputting the page data extracted by the page extraction unit.

3. The image processing apparatus according to claim 1, wherein the page information includes:
page number information indicating a page number of the page; and
start address information indicating a start address of the page data on the image data.

4. The image processing apparatus according to claim 1, comprising a page information storage portion storing the page information,
wherein the page information storage portion is positioned in a top or an end of the page of each of page data on the image data.

5. The image processing apparatus according to claim 1 further comprising,
a page information providing unit providing the page information to the image data,
wherein the page extraction unit retrieves the page data of the image data and provides the page information to the image data through the page information providing unit in a case where the page information is not confirmed from the image data.

6. The image processing apparatus according to claim 1, wherein the image data are having any of a PDF format, an XPS format, a PostScript format, a PCL format, and a HTML format.
